(19) United States
(12) Patent Application Publication
(10) Pub. No.: US 2026/0309678 A1
(43) Pub. Date: Oct. 8, 2026

(54) ULTRASONIC TESTING SYSTEMS AND RELATED DEVICES AND METHODS

(71) Applicant: Sinewave Solutions, LLC, Salt Lake City, UT (US)

(72) Inventor: Paul T. Hayes, Salt Lake City, UT (US)

(21) Appl. No.: 19/641,132

(22) Filed: Apr. 7, 2026

Related U.S. Application Data
(60) Provisional application No. 63/785,391, filed on Apr. 8, 2025.

(51) Int. Cl. G01N 29/34; G01N 29/06; G01N 29/32

(52) U.S. Cl. CPC G01N 29/343; G01N 29/069; G01N 29/326

(57) ABSTRACT

An ultrasonic transducer system includes a monolithic transducer configured to transmit one or more acoustic waves into a medium and an array transducer configured to receive one or more acoustic waves from the medium. An ultrasonic testing device may be configured to transmit one or more electrical pulses toward the monolithic transducer and to receive one or more electrical signals via the array transducer. A voltage pulser device may be disposed electrically between the ultrasonic testing device and the monolithic transducer. The voltage pulser device is configured to receive the one or more electrical pulses from the ultrasonic testing device and to provide one or more corresponding electrical pulses to the monolithic transducer responsive to the one or more electrical pulses, thereby facilitating generation of the one or more acoustic waves in the medium.

### CROSS-REFERENCE TO RELATED APPLICATIONS

This application claims the benefit under 35 U.S.C. § 119 (e) of U.S. Provisional Patent Application Ser. No. 63/785,391, filed Apr. 8, 2025, the disclosure of which is hereby incorporated herein in its entirety by this reference.

### TECHNICAL FIELD

Embodiments of the disclosure relate generally to ultrasonic testing systems and devices for non-destructive testing, and more particularly to voltage pulser devices and transducer configurations for generating and receiving acoustic waves within a medium.

### BACKGROUND

Non-destructive testing (NDT) is a field that encompasses a variety of test methods that may be used to evaluate materials, components, or structures without impairing their future usefulness. Inspection techniques that may be employed in NDT applications include, for example, radiography, magnetic particle inspection, liquid penetrant inspection, eddy current inspection, and others. Ultrasonic testing (UT) is one such method within the field of NDT and has been widely used to evaluate a range of material mediums commonly used in construction and in components of public and industrial infrastructure (e.g., pipes, welds, valves, aircraft components, steel beams, etc.). UT may be used to assess structural integrity, identify defects, and support continued service life, predictive maintenance, and asset integrity programs. In operation, UT generally involves inducing ultrasonic wave energy into a medium and detecting reflected energy to identify internal features or discontinuities. While many materials are conducive to ultrasonic inspection and yield reliable results, certain materials present challenges for conventional UT systems. For example, some materials may exhibit coarse grain structures or other characteristics that scatter and attenuate ultrasonic energy, thereby reducing signal quality and limiting the ability to obtain meaningful inspection data.

Ultrasonic inspection is used across a wide range of industries for evaluating materials and structures for quality assurance and defect detection. However, because ultrasonic waves propagate as pressure waves, their transmission through a medium may be significantly affected by material properties. In some materials, ultrasonic energy may be highly attenuated or scattered, resulting in reduced penetration depth and degraded signal-to-noise characteristics. As a result, certain materials may be difficult or impractical to inspect using conventional ultrasonic testing techniques. By way of example, a significant portion of power generation infrastructure includes components formed from cast austenitic stainless steel (CASS), which may exhibit material properties that hinder effective ultrasonic inspection. Such challenges highlight the need for improved ultrasonic testing approaches that can provide reliable inspection results across a broader range of materials and operating conditions.

### BRIEF SUMMARY

In one aspect, an ultrasonic transducer system is provided. The system may include a monolithic transducer configured to transmit one or more acoustic waves into a medium and an array transducer configured to receive one or more acoustic waves from the medium. An ultrasonic testing device may be configured to transmit one or more electrical pulses toward the monolithic transducer and to receive one or more electrical signals via the array transducer. A voltage pulser device may be disposed electrically between the ultrasonic testing device and the monolithic transducer. The voltage pulser device is configured to receive the one or more electrical pulses from the ultrasonic testing device and to provide one or more corresponding electrical pulses to the monolithic transducer responsive to the one or more electrical pulses, thereby facilitating generation of the one or more acoustic waves in the medium.

In another aspect, a method of performing non-destructive testing is provided. The method may include receiving or generating a first voltage signal at a voltage pulser device and providing, via the voltage pulser device, a second voltage signal to a monolithic transducer structure responsive to the first voltage signal, the second voltage signal having a voltage greater than a voltage of the first voltage signal. The method may further include providing one or more acoustic waves to a medium using the monolithic transducer structure, the one or more acoustic waves based, at least in part, on the second voltage signal.

In a further aspect, an apparatus including a voltage pulser device is provided. The voltage pulser device may include a trigger input line and a pulse output line, the trigger input line configured to be coupled to an ultrasonic testing device coupled to an array transducer structure, and the pulse output line configured to be coupled to a monolithic transducer structure. The voltage pulser device may be configured to receive a first voltage signal at the trigger input line, generate a second voltage signal responsive to the first voltage signal, the second voltage signal having a voltage greater than a voltage of the first voltage signal, and provide the second voltage signal at the pulse output line for driving the monolithic transducer structure to generate one or more acoustic waves to a medium.

### BRIEF DESCRIPTION OF THE SEVERAL VIEWS OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a schematic diagram of an ultrasonic transducer (UT) system in accordance with one or more embodiments of the disclosure;

FIG. 2 is a bottom view of a probe including an array transducer and a monolithic transducer in accordance with one or more embodiments of the disclosure;

FIG. 3 is a flowchart illustrating an example operation of an ultrasonic transducer system in accordance with one or more embodiments of the disclosure;

FIG. 4 shows an example image generated by a UT device based, at least in part, on a signal received from an array transducer in accordance with one or more embodiments of the disclosure;

FIG. 5 shows a line diagram of an example negative pulse voltage signal generated by a UT device in accordance with one or more embodiments of the disclosure;

FIG. 6A is a cross-sectional amplitude map of longitudinal waves being transmitted at a 45-degree angle from transducer into a coarse-grained weld material in accordance with one or more embodiments of the disclosure;

FIG. 6B is a cross-sectional heat map of shear waves as they pass through the coarse-grained weld material at a 45-degree angle from a transducer in accordance with one or more embodiments of the disclosure;

FIG. 7 is a schematic block diagram of a voltage pulser device in accordance with one or more embodiments of the disclosure;

FIG. 8A is a schematic block diagram of a voltage pulser device in accordance with one or more other embodiments of the disclosure;

FIG. 8B is a schematic block diagram of a pulse repetition rate generator of the voltage pulser device of FIG. 8A in accordance with one or more embodiments of the disclosure;

FIG. 8C is a schematic block diagram of a rising/falling edge trigger selector of the voltage pulser device of FIG. 8A in accordance with one or more embodiments of the disclosure; and

FIG. 9 is a block diagram of circuitry that, in some examples, may be used to implement various functions, operations, acts, processes, and/or methods disclosed herein.

### DETAILED DESCRIPTION

Non-destructive testing (NDT) is a set of techniques used to evaluate the integrity, properties, and serviceability of materials, components, or systems without causing damage to the materials, components, or systems. The objective of NDT is to detect defects, irregularities, or changes in material properties that could compromise safety, performance, or reliability, while preserving the usability of the inspected part. NDT may be employed in a variety of industries, including aerospace, oil and gas, automotive, power generation, construction, and manufacturing, where maintaining structural integrity is critical.

One form of non-destructive testing is ultrasonic testing (UT). Ultrasonic testing may utilize high-frequency acoustic waves generated by a transducer to propagate into a medium, with reflected acoustic energy being received and analyzed to identify internal features such as defects or thickness variations. Various wave modes may be employed, including longitudinal waves, shear waves, surface waves, and plate waves, each having different propagation characteristics. For example, longitudinal waves may provide greater penetration in attenuative materials, while shear waves may provide increased sensitivity to certain types of defects. The selection of wave mode may therefore impact inspection performance depending on the material and application.

Different ultrasonic testing approaches may be used, such as pulse-echo testing and pitch-catch testing, each having associated advantages and tradeoffs. In some configurations, a single transducer element may be used to both transmit and receive acoustic waves, while in other configurations separate transmitting and receiving elements may be employed. Received signals may be processed and reconstructed to generate an image (e.g., a two-dimensional representation) that may illustrate one or more features or defects within the material.

Certain materials, such as coarse-grained or otherwise highly attenuative materials, may present challenges for ultrasonic inspection. For example, grain structure and material composition may cause scattering and attenuation of acoustic waves, reducing penetration depth and degrading signal quality. While lower frequency transducers may improve penetration due to longer wavelengths, such configurations may reduce image resolution. Similarly, larger transducer elements may provide increased acoustic energy and penetration, but may introduce other practical limitations. In addition, array transducers may provide improved imaging capability, but may be limited in the amount of drive voltage that can be applied without risking damage to individual array elements.

In some conventional ultrasonic testing systems, particularly those employing phased array techniques, operating voltages may be reduced to protect array transducer elements and to manage noise. For example, some systems may operate at voltages in a range of about 150 V to about 200 V, whereas other systems may utilize higher voltages. Reduced drive voltage may limit the ability to effectively penetrate attenuative materials, thereby impacting inspection capability. As a result, there may be a need to balance penetration capability, signal quality, and system reliability.

Accordingly, ultrasonic testing systems may be configured to provide enhanced signal generation and improved flexibility in transmitting and receiving acoustic waves within a medium. For example, in some embodiments, a system may include a voltage pulser device disposed between an ultrasonic testing device and a transmitting transducer, such as a monolithic transducer structure, to facilitate generation of acoustic waves in the medium. In some embodiments, a receiving transducer, such as an array transducer structure, may be used to receive acoustic waves from the medium and provide corresponding signals for analysis. Such configurations may enable improved penetration of acoustic waves while maintaining the ability to generate detailed inspection data.

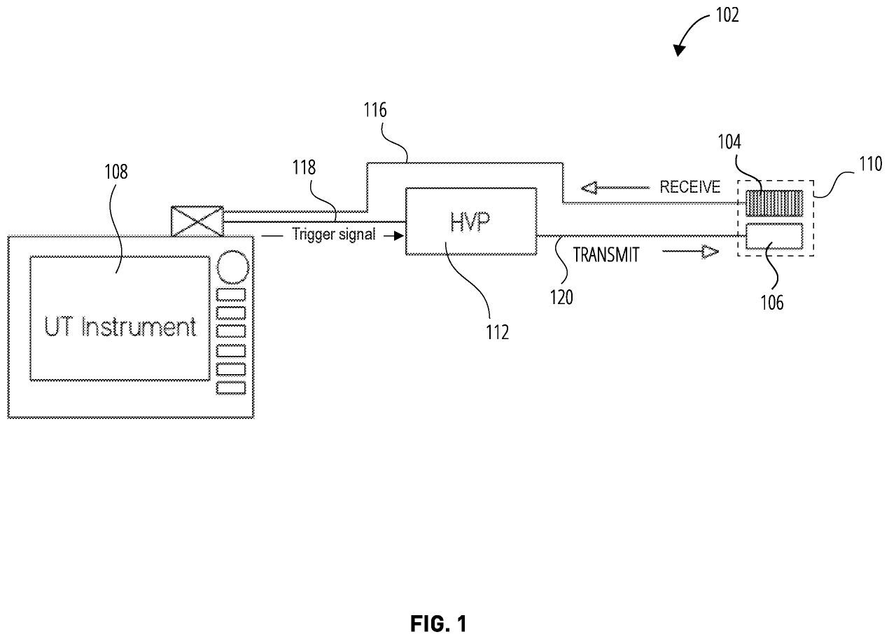

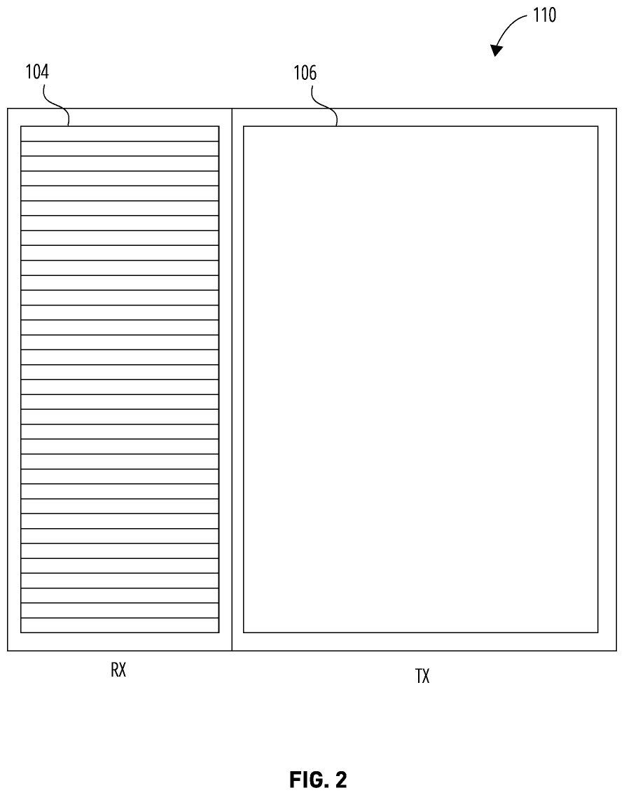

FIG. 1 is a schematic diagram of an ultrasonic transducer (UT) system 102 in accordance with one or more embodiments of the disclosure. The UT system 102 includes an ultrasonic testing (UT) device 108, a voltage pulser device 112, and a probe 110. The probe 110 includes an array transducer 104 and a monolithic transducer 106. FIG. 2 is a bottom view of the probe 110 including the array transducer 104 and the monolithic transducer 106 in accordance with one or more embodiments of the disclosure.

In FIG. 1, the voltage pulser device 112 is in electrical communication with the monolithic transducer 106 of the probe 110 via electrically conductive line 120. The UT device 108 may be in electrical connection with the voltage pulser device 112 via electrically conductive line 118 and with the array transducer 104 of the probe 110 via electrically conductive line 116. In some embodiments, UT device 108 may be in electrical connection with the voltage pulser device 112 via a plurality of conductive lines.

With respect to the probe 110, the monolithic transducer 106 may be used for transmission of acoustic waves, while the array transducer 104 may be used for reception of acoustic waves. The array transducer 104 may include a plurality of transducer elements (e.g., a multi-element array), which may be configured to receive acoustic waves at multiple spatial locations and generate corresponding electrical signals. In contrast, the monolithic transducer 106 may include a single, continuous piezoelectric structure configured to generate high-energy acoustic waves. As used herein, the term “monolithic transducer” may refer to a transducer structure including a single, unitary transducing element or structure, such as a single piezoelectric crystal or an integrated transducing body, in contrast to a multi-element or array transducer structure. Such a configuration, in which a monolithic transmitting transducer is used in combination with a multi-element array receiving transducer, may provide improved signal penetration and imaging capability, particularly in materials that exhibit high attenuation or scattering.

In some embodiments, the UT device 108 may comprise a flaw detector (e.g., otherwise referred to herein as a user flaw detector, or a portable ultrasonic flaw detector), which may be configured for manual or field-based non-destructive testing operations. As used herein, the term “ultrasonic testing device” may broadly refer to any device configured to generate and/or receive ultrasonic signals for inspection purposes, including, without limitation, ultrasonic flaw detectors, phased array ultrasonic testing (PAUT) systems, immersion testing systems, automated or robotic inspection systems, or other ultrasonic inspection instruments. Accordingly, references to a flaw detector may be understood as one example implementation of an ultrasonic testing device. In some embodiments, the UT device 108 may include at least one processing device and at least one non-transitory computer readable storage medium (e.g., memory) that may include instructions that, when executed by the UT device 108, may cause the UT device 108 to perform certain actions, such as providing voltage signals to the voltage pulser device 112 and generating one or more images based on signals received from the array transducer 104.

In some embodiments, the voltage pulser device 112 is configured to generate a voltage signal responsive to a voltage signal received from the UT device 108. In some examples, the voltage signal generated by the voltage pulser device 112 has a voltage greater than the voltage of the voltage signal generated from the UT device 108. The voltage pulser device 112 may receive an output (e.g., a pulse voltage, a transistor to transistor logic (TTL) output, or any conventional output such as an encoder, without limitation) from the UT device 108 (e.g., via one or more conductive lines connecting the UT device 108 and the voltage pulser device 112) and, responsive to the received output from the UT device 108, generate a voltage signal and provide the voltage signal to the probe 110 via the line 120. In some embodiments, the voltage signal received from the UT device 108 may be or include one or more first voltage pulse signals (or more generally, one or more electrical pulses), and the voltage pulser device 112 may generate one or more second voltage pulse signals (or more generally, one or more corresponding electrical pulses) responsive to the first voltage pulse signals, where the second voltage pulse signals have a voltage greater than a voltage of the first voltage pulse signals.

As depicted in the example arrangement, the voltage pulser device 112 is placed in-line between the UT device 108 and the probe 110 (e.g., in-line between the user flaw detector and the monolithic transducer 106). When the UT device 108 generates one or more first voltage pulse signals and provides the signals to the voltage pulser device 112, the voltage pulser device 112 may produce one or more second voltage pulse signals based, at least in part, on the one or more first voltage pulse signals received from the UT device 108. In some embodiments, the one or more second voltage pulse signals may be generated based, at least in part, on a pulse duration of the one or more first voltage pulse signals, such that a pulse width of the one or more second voltage pulse signals corresponds to, or is derived from, the pulse width of the one or more first voltage pulse signals.

The voltage pulser device 112 may be triggered by one or more voltage pulse signals received from the UT device 108. In one example, a detected voltage (e.g., as small as 5 V) from the UT device 108 may cause the voltage pulser device 112 to generate a voltage pulse signal in response to the detected voltage. As the one or more voltage pulse signals enter the voltage pulser device 112, its timing characteristics can be detected and processed by the device and then similarly replicated. Accordingly, one or more corresponding voltage pulse signals having an increased voltage based, at least in part, on the one or more voltage pulse signals received from the UT device 108 may be transmitted to the monolithic transducer 106. The monolithic transducer 106 may convert the received voltage pulse signals to acoustic waves to communicate the acoustic waves to a volume (e.g., a medium).

In some embodiments, the voltage pulser device 112 may have a power source (e.g., a direct power source or an energy storage device) separate from a power source of the UT device 108 or the probe 110. The voltage pulser device 112 may be configured to output a voltage higher than a maximum voltage of the UT device 108. For example, the voltage pulser device 112 may generate a voltage within a range from about 100 V to about 900 V. As a specific, non-limiting example, the voltage pulser device 112 may be tunable between four voltage presets including 200 V, 400 V, 600 V, or 800 V. In some embodiments, at least one Gallium Nitride Field Effect Transistor (GaN FET) may be used for a pulse transistor, which may facilitate a voltage higher than may be typically seen output by typical UT devices.

In some embodiments, the voltage pulser device 112 may output a pulse with a square-shaped waveform (e.g., a positive or negative square waveform). Furthermore, the voltage pulser device 112 may be tunable such that the pulse duration (e.g., the pulse width) of each pulse may be tunable to a frequency of a transducer (e.g., from about 100 ns to about 1000 ns), which may accommodate transducer frequencies from about 0.1 MHz to about 5.0 MHz. In some embodiments, the UT device 108 may be configured to generate the one or more first voltage pulse signals having a pulse width adjustable within a range from about 100 ns to about 1000 ns, and the voltage pulser device 112 may generate the one or more second voltage pulse signals based, at least in part, on the pulse width of the first voltage pulse signals. Though discussed in terms of specific frequencies, any suitable frequency range may be utilized depending on the application.

A pulse width may be a length of time that a voltage is applied to a transducer, such as a monolithic crystalline structure, which may be different depending on the frequency. For example, a pulse width (PW) may be calculated as PW=(1/frequency)/2. For instance, the following example frequencies may align with the corresponding pulse width durations as depicted in Table 1 provided below:

TABLE 1
Frequency with corresponding pulse width durations.

| | |
|---|---|
| Frequency | Pulse Width Duration |

| | | | |
|---|---|---|---|
| 10 | MHz | 50 | ns |
| 5 | MHZ | 100 | ns |
| 2.25 | MHz | 222 | ns |
| 1.5 | MHz | 333 | ns |
| 1 | MHz | 500 | ns |
| 0.5 | MHz | 1000 | ns |

Accordingly, in some embodiments, a stronger, more penetrating sound wave may be generated from the higher voltage being applied to the transducer than otherwise possible. Higher voltage may be more suitable to drive the larger monolithic transmitting crystal due to the physical size (thickness) of the ceramic crystal. In some embodiments, the voltage pulser device 112 may be tunable from about 5 V to about 800 V. Furthermore, the voltage pulser device 112 is configured to generate an adjustable pulse width, a duration of which may be adjustable from about 100 ns to about 1000 ns. This amount of adjustment may be required to accommodate different frequencies of transducers from about 2.50 MHz down to about 200 KHz.

As is apparent, the UT system 102 of FIG. 1 includes the voltage pulser device 112 disposed electrically between the UT device 108 and a transmitting transducer, such as the monolithic transducer 106. The voltage pulser device 112 may be configured to receive a first voltage pulse signal from the UT device 108 and to generate a second voltage pulse signal having a greater voltage than the first voltage pulse signal for driving the monolithic transducer 106. In this manner, the voltage pulser device 112 may operate as an intermediate signal conditioning and amplification stage that is physically and electrically distinct from both the UT device 108 and the monolithic transducer 106. In some embodiments, such a configuration may enable the UT device 108 to operate at lower voltage levels while the voltage pulser device 112 provides higher voltage excitation to the monolithic transducer 106, which may further facilitate the use of separate transmitting and receiving transducer structures, such as the monolithic transducer 106 and the array transducer 104, within the UT system 102.

In some embodiments, the voltage pulser device 112 may include a processing device (e.g., a microcontroller or a microprocessor) having one or more processor cores and operably coupled to memory that stores firmware. The processing device may be configured to control operation of the voltage pulser device 112, including selection of trigger sources, adjustment of pulse parameters (e.g., pulse width, pulse repetition rate, voltage level, and so on), switching control, and/or coordination of signal flow through the device.

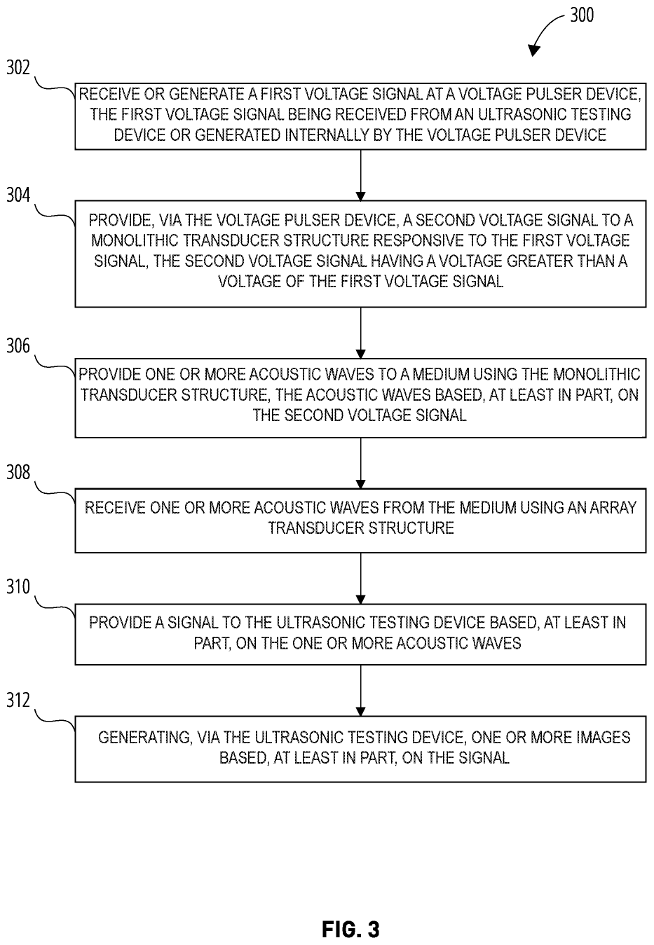

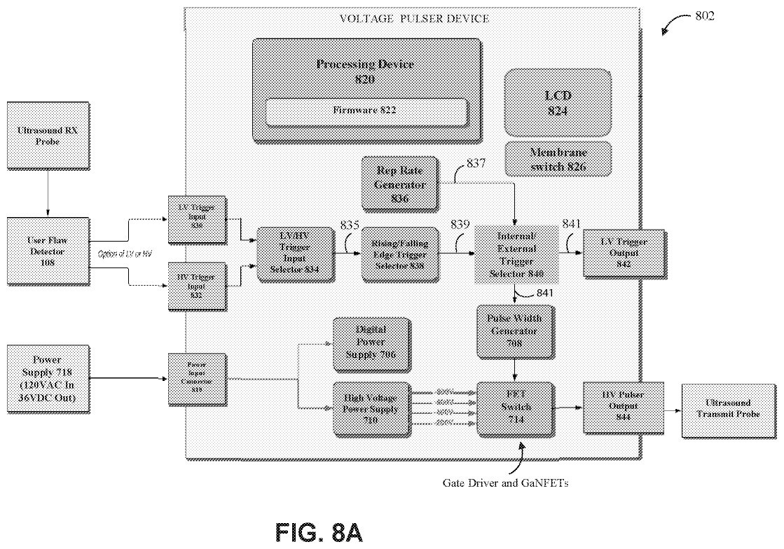

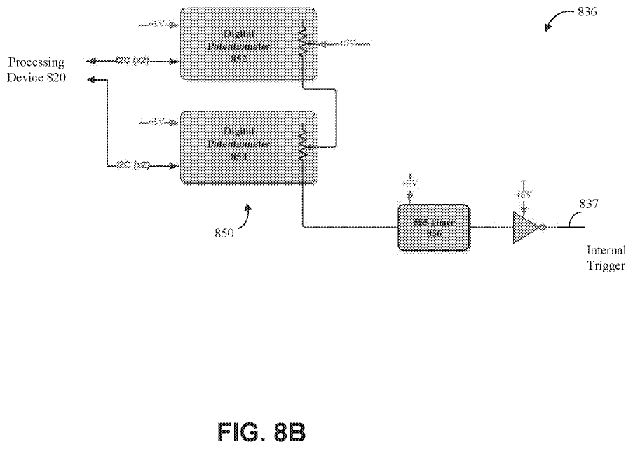

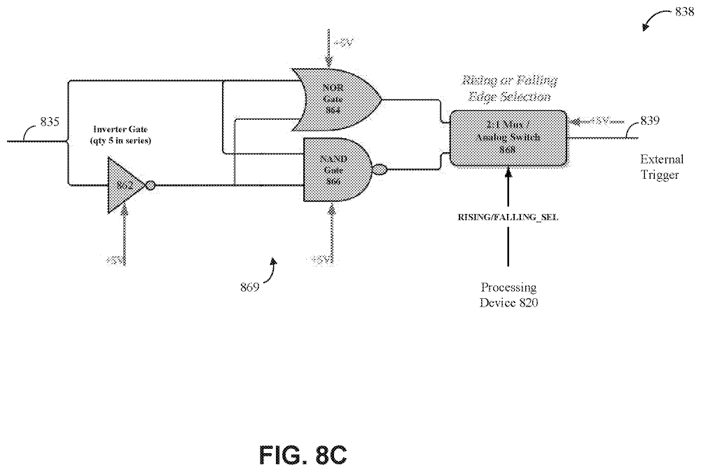

In the embodiments described above, the voltage pulser device 112 operates in an external trigger mode in which one or more first voltage pulse signals are received from the ultrasonic testing device 108 and used to control generation of one or more second voltage pulse signals. In some embodiments, however, the voltage pulser device 112 may be configured to operate in an internal trigger mode as an alternative to the external trigger mode. In the internal trigger mode, the voltage pulser device 112 may internally generate the one or more first voltage pulse signals without receiving the signals from the ultrasonic testing device 108, and may generate the one or more second voltage pulse signals responsive to the internally generated one or more first voltage pulse signals. In some embodiments, operation in the internal trigger mode may be initiated based on a user selection or other control input, and may provide additional flexibility in operation of the voltage pulser device 112. Further discussion regarding internal pulse generation is described later below with reference to FIG. 3 and FIGS. 8A-8C.

In FIG. 1, the probe 110 may operate in response to the electrical pulses from the voltage pulser device 112, and be configured to transmit and receive one or more acoustic waves provided to and received from a medium (e.g., a coarse grain material). For example, the monolithic transducer 106 may be configured to convert an electrical signal to an acoustic wave and transmit the acoustic wave. The probe 110 may also be configured to transmit and receive any number of waveform types (e.g., any ultrasonic wave mode or waveform components). When the probe 110, and particularly the monolithic transducer 106, is in contact with a medium such as a coarse grain material, the acoustic waves transmitted by the monolithic transducer 106 responsive to the voltage may be provided to the medium. For example, the monolithic transducer 106 may include a monolithic piezoelectric crystal that may, when introduced to a voltage, vibrate, thereby creating acoustic waves in a surrounding medium such as a medium in contact with the probe 110 or the monolithic transducer 106 of the probe 110.

The array transducer 104 may be configured to receive one or more acoustic waves from a medium (e.g., reflections of the acoustic waves provided to the medium via the monolithic transducer 106) and generate one or more electrical signals (e.g., voltages) based, at least in part, on the received acoustic waves. For example, the array transducer 104 may be in the form of a multi-element crystalline array transducer that includes a plurality of piezoelectric elements (e.g., bulk or monolithic piezoelectric ceramics such as lead zirconate titanate (PZT), PZT composite materials, quartz, without limitation). Incoming acoustic waves may impinge on the array transducer 104, causing respective elements of the array to deform due to mechanical stress associated with the acoustic waves. Such deformation may create a separation of charges within each element, thereby generating a voltage difference across corresponding surfaces of the elements, which may be proportional to an intensity of the received acoustic waves and converted into electrical signals. In some embodiments, the array transducer 104 may include 64 piezoelectric elements that form the array structure of the array transducer 104. In other embodiments, however, any number of piezoelectric elements, and in any element configuration or arrangement, may be used.

In some embodiments, the monolithic transducer 106 and the array transducer 104 may each be acoustically coupled to the medium while remaining electrically isolated from one another. For example, the monolithic transducer 106 may be electrically coupled to the voltage pulser device 112 for transmission of high-voltage excitation signals, while the array transducer 104 may be electrically coupled to the UT device 108 to provide electrical signals corresponding to acoustic waves received at the array transducer 104. Such separation of transmit and receive signal paths may reduce exposure of the array transducer 104 and associated receive circuitry to high-voltage signals, thereby mitigating potential damage to receive-side components.

In some embodiments, the UT device 108 may apply one or more imaging schemes (e.g., the Total Focusing Method) to generate one or more images based, at least in part, on signals received from the array transducer 104. For instance, such imaging schemes may include plane wave imaging, phase coherence imaging, synthetic aperture focusing technique, delay-and-sum processing, or migration (e.g., inverse wave extrapolation), which may be used to generate one or more images representative of a volume of the medium that received the one or more acoustic waves. Such imaging schemes may involve processing signals received from multiple transducer elements of the array transducer 104 to form the image.

Reflecting energy (e.g., one or more reflections of the one or more acoustic waves) from within the volume of a component may be received by the array transducer 104 to generate elementary A-scans. The A-scans may be provided to the UT device 108, which may process the A-scans to generate one or more images. In some embodiments, the UT device 108 may be configured to generate the one or more images by performing a summation processing algorithm on the A-scans or corresponding electrical signals received from the array transducer 104. For example, such summation processing may include delay-and-sum beamforming, synthetic aperture focusing, or other signal combination techniques in which signals associated with different transducer elements are combined to enhance image resolution and signal-to-noise characteristics. In some embodiments, where separate transmitting and receiving transducers are not employed, such summation processing may be reduced or omitted.

In some embodiments, the probe 110 may include one or more heatsink devices or other cooling devices configured to dissipate heat generated during operation. For example, such cooling devices may include passive heatsinks, fan-assisted heatsinks, liquid-cooled heatsinks, or other suitable thermal management structures. In some embodiments, the cooling device may be thermally coupled to the monolithic transducer 106 and configured to reduce an operating temperature of the monolithic transducer 106, for example, to dissipate heat associated with high-voltage excitation of the monolithic transducer 106 during operation.

Though discussed in terms of a hybrid probe having the monolithic transducer 106 as a transmitter and the array transducer 104 as a receiver for the probe 110, the probe 110 may also include any combination thereof in other embodiments of the disclosure. For example, the probe 110 may include two monolithic transducers for transmitting and receiving or two array transducers for transmitting and receiving. Furthermore, in some embodiments, the probe 110 may have the array transducer 104 be in connection with the voltage pulser device 112 via the lines 120 such that the array transducer 104 may be used to transmit one or more acoustic waves into a medium and may also have the monolithic transducer 106 in connection with the UT device 108 via lines 116 and be configured to receive one or more acoustic waves from the medium.

FIG. 3 is a flowchart of a method 300 of operation for an ultrasonic transducer system (e.g., UT system 102 of FIG. 1) in accordance with one or more embodiments of the disclosure. For example, the method 300 may illustrate a sequence flow that the UT system 102 may utilize to conduct UT on a medium and generate images indicative of acoustic waves associated with the medium.

At operation 302, a first voltage signal may be received or generated at the voltage pulser device 112. In some embodiments, the first voltage signal may be received from the UT device 108 via the line 118. For example, the line 118 may form or include a trigger input line of the voltage pulser device 112, and the first voltage signal may include one or more first voltage pulse signals received at the trigger input line. In other embodiments, the first voltage signal may be generated internally by the voltage pulser device 112. For example, the first voltage signal may include one or more internally generated first voltage pulse signals generated within the voltage pulser device 112 independent of the trigger input line.

At operation 304, a second voltage signal is provided, via the voltage pulser device 112, to the monolithic transducer 106 responsive to the first voltage signal. In some embodiments, the second voltage signal has a voltage that is greater than a voltage of the first voltage signal. In some embodiments, the second voltage signal may include one or more second voltage pulse signals generated responsive to the one or more first voltage pulse signals. For example, the line 118 may be in connection with a pin of the voltage pulser device 112 where the voltage pulser device 112 is configured to detect (e.g., via processing circuitry or hardwiring) the one or more first voltage pulse signals at the pin. In response to detecting the one or more first voltage pulse signals at the pin, the voltage pulser device 112 may generate the one or more second voltage pulse signals (e.g., a negative pulse voltage signal) having a pulse voltage greater than the one or more first voltage pulse signals.

At operation 306, the UT system 102 may provide one or more acoustic waves to a medium (e.g., a coarse-grained material, such as cast austenitic stainless steel (CASS)) using the monolithic transducer structure, the acoustic waves based, at least in part, on the second voltage. For example, upon receiving the second voltage from the voltage pulser device 112, the second voltage may cause the monolithic transducer 106 to vibrate, thereby causing the monolithic transducer 106 to transmit one or more acoustic waves which, when the probe 110 is proximate to the medium, may be communicated or otherwise transmitted to the medium.

At operation 308, the UT system 102 may receive one or more acoustic waves from the medium using the array transducer 104. For example, the array transducer 104 may receive one or more reflected or otherwise transmitted acoustic waves that were transmitted by the monolithic transducer 106.

At operation 310, the UT system 102 may provide a signal to the UT device 108 based, at least in part, on the one or more acoustic waves received by the array transducer 104. For example, when the array transducer 104 receives one or more acoustic waves, it may cause the array transducer 104 to generate an electrical signal or voltage which may then be transmitted to the UT device 108 via line 116.

At operation 312, the UT system 102 may generate, via the UT device 108, one or more images based, at least in part, on the signal.

In a specific, non-limiting example of operation 302, the UT device 108 may be configured to provide a voltage signal having a voltage of about 150 V to a device connected to the line 118. However, the UT device 108 may provide any suitable signal or voltage to a device in connection with line 118; for example, the UT device 108 may provide any voltage capable of being produced by traditional UT devices used for providing a voltage to a transducer for the purposes of performing ultrasonic testing. In the specific, non-limiting example, the UT device 108 may be configured to generate a square wave pulse of about 150 V and, via line 118, provide the 150 V pulse to the voltage pulser device 112 in operation 304. Upon detection of the 150 V pulse, the voltage pulser device 112 may generate a square wave pulse of about 800 V and provide the voltage to line 120 to the monolithic transducer 106.

Thus, according to the method 300 of FIG. 3, a first voltage signal is received or generated at the voltage pulser device. In one or more examples, the first voltage signal is either received from the ultrasonic testing device or generated internally by the voltage pulser device based on a selection input. In some embodiments, the first voltage signal includes one or more first voltage pulse signals (e.g., one or more electrical pulses). A second voltage signal is provided, via the voltage pulser device, to a monolithic transducer structure responsive to the first voltage signal. In some embodiments, the second voltage signal includes one or more second voltage pulse signals (e.g., one or more corresponding electrical pulses) having a voltage greater than a voltage of the first voltage pulse signals. One or more acoustic waves are provided to a medium using the monolithic transducer structure, where the acoustic waves are based at least in part on the second voltage signal. One or more acoustic waves are then received from the medium using an array transducer structure, and a signal is provided to the ultrasonic testing device based, at least in part, on the one or more received acoustic waves. In one or more examples, one or more images are generated, via the ultrasonic testing device, based at least in part on the signal.

In one or more specific examples of the method 300 of FIG. 3, the first voltage signal may be a low-voltage trigger signal having a voltage in a range from about 5 V to about 15 V, or a high-voltage trigger signal having a voltage of about 50 V. In one or more examples, the voltage pulser device may be configured to generate output voltages over a broader range, such as from about 5 V to about 450 V, and the second voltage signal may be within a range from about 100 V to about 900 V.

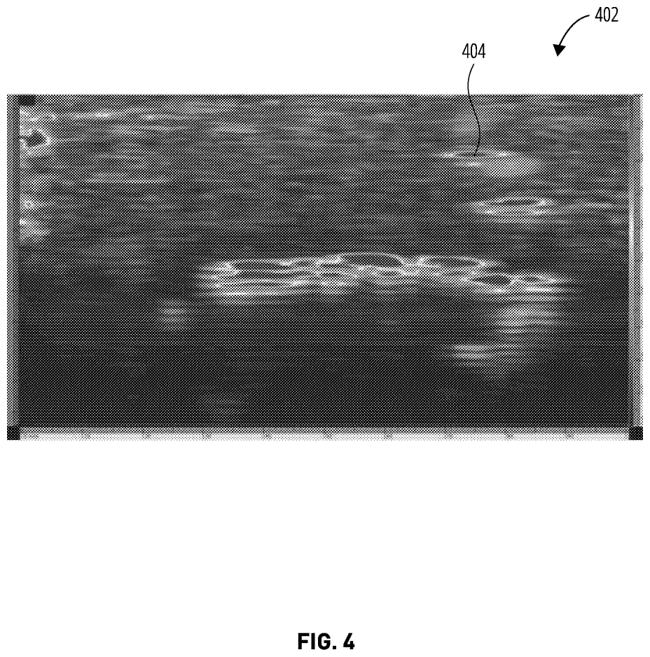

FIG. 4 shows an example image 402 generated by the UT device 108 based, at least in part, on a signal received from the array transducer 104 in accordance with one or more embodiments of the disclosure. As shown in FIG. 4, the image 402 may be an image constructed from amplitude based A-scans, Phase Coherence, or the frequency spectrum, etc., where contrasting colors represent possible flaws or defects (e.g., a characteristic 404 in the image 402) in a medium.

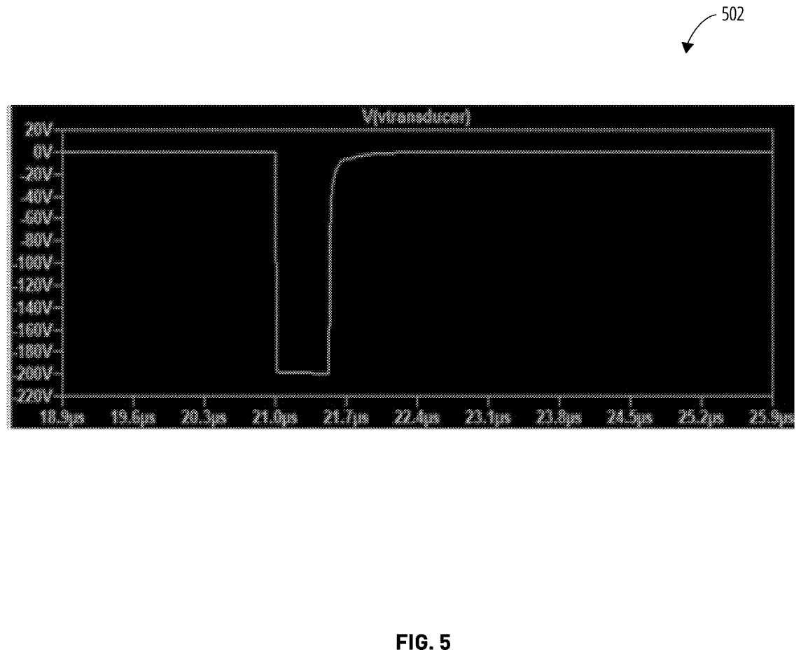

FIG. 5 shows a line diagram of an example negative pulse voltage signal 502 generated by the UT device 108 in accordance with one or more embodiments of the disclosure. In some embodiments, the negative pulse voltage signal 502 may represent an electrical pulse provided by the UT device 108 for use in controlling or initiating operation of a voltage pulser device. In at least some contexts, the negative pulse voltage signal 502 may be and/or be referred to as a negative square wave pulse signal. The waveform may include a transition to a negative voltage level followed by a return toward a baseline level, and may be characterized by a defined pulse width and amplitude. Such characteristics may be used by the voltage pulser device to generate a corresponding output signal.

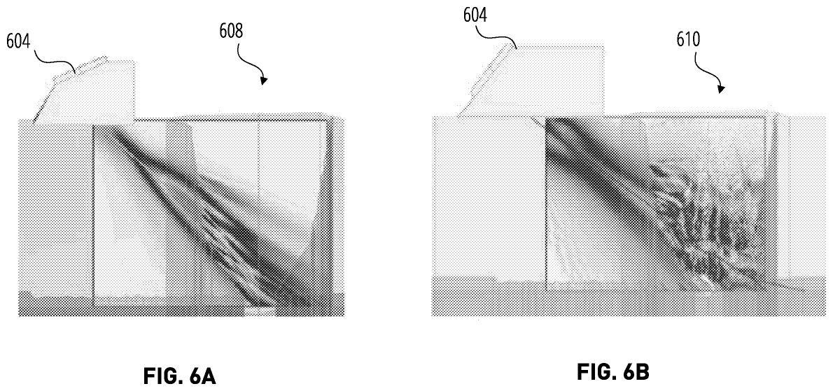

FIG. 6A is a cross-sectional amplitude map 608 of longitudinal waves being transmitted at a 45-degree angle from a transducer 604 (e.g., a probe assembly including a wedge or shoe and a transducer element) into a coarse-grained weld material in accordance with one or more embodiments of the disclosure. FIG. 6B is a cross-sectional heat map 610 of shear waves as they pass through the coarse-grained weld material at a 45-degree angle from transducer 604 in accordance with one or more embodiments of the disclosure.

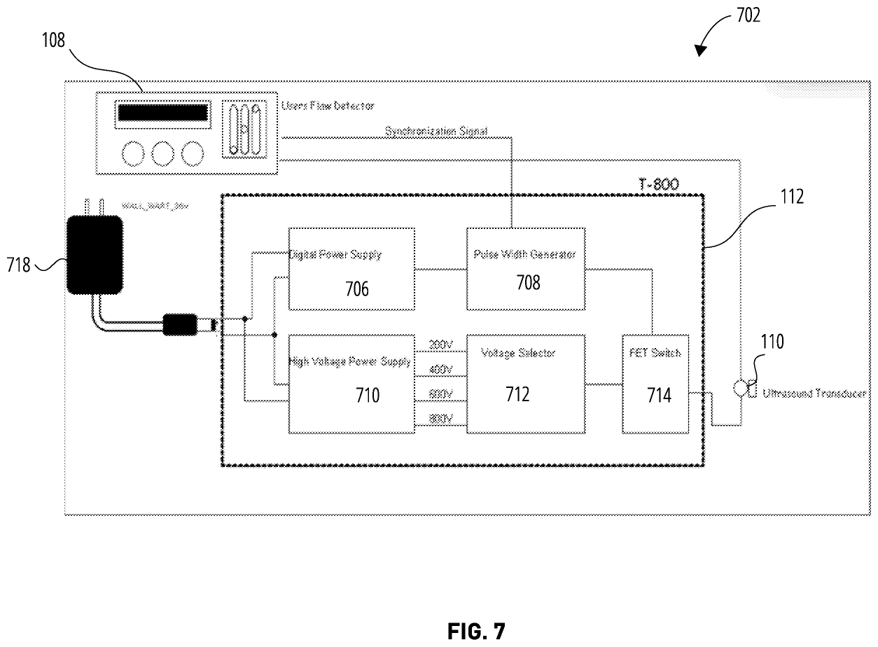

FIG. 7 is a schematic block diagram 702 of the voltage pulser device 112 in accordance with one or more embodiments of the disclosure. The voltage pulser device 112 includes a digital power supply 706 (or low voltage power supply(s)), a high voltage power supply 710, a pulse width generator 708, a voltage selector 712, and a Field Effect Transistor (FET) switch 714. The digital power supply 706 and/or high voltage power supply 710 may be in electrical connection with the power source 718. The UT device 108 may be in connection with the pulse width generator 708 and provide a signal to be detected at the pulse width generator 708 (e.g., a voltage above a predetermined threshold). The pulse width generator 708 may be configured to generate a wave form for a voltage and provide the wave form to the FET switch 714. The voltage selector 712 may be configured to allow a specific voltage to be provided to the FET switch 714. For example, as shown in FIG. 7, the voltage selector 712 may select between 200 V, 400 V, 600 V, and 800 V. The FET switch 714 may be configured to communicate the selected voltage having a waveform generated by the pulse width generator 708 to the probe 110. Though shown having only one FET switch, any number may be used. For instance, the voltage pulser device 112 may include a plurality of FETs and/or FET switches.

In some embodiments, the pulse width generator 708 may be configured to receive an input signal from the UT device 108 and to generate a corresponding control signal defining a pulse duration for an output voltage pulse. For example, the pulse width generator 708 may be configured to detect a trigger signal (e.g., a voltage exceeding a threshold) and to generate a waveform having a defined pulse width corresponding to a desired transducer operating frequency. The generated waveform may be provided to the FET switch 714, which may be configured to selectively couple a selected voltage to an output line in accordance with the waveform.

In some embodiments, the voltage selector 712 may be configured to select one of a plurality of voltage levels provided by the voltage power supply 710. For example, the voltage selector 712 may include switching circuitry configured to select between discrete voltage levels (e.g., approximately 200 V, 400 V, 600 V, or 800 V), though other voltage levels may be used. The selected voltage may be provided to the FET switch 714, which may apply the selected voltage to the output in accordance with the waveform generated by the pulse width generator 708.

In some embodiments, the FET switch 714 (e.g., including one or more GaN FET devices) may be configured to rapidly switch the selected voltage to generate a pulse waveform suitable for driving a transducer. For example, the FET switch 714 may be configured to generate a square wave or substantially square wave pulse having fast rise and fall times. The use of GaN-based switching devices may enable higher voltage operation, faster switching speeds, and improved efficiency relative to conventional switching devices.

In some embodiments, the digital power supply 706 and the voltage power supply 710 may be configured to provide regulated power to the various components of the voltage pulser device 112. For example, the digital power supply 706 may provide lower voltage power for control circuitry, while the voltage power supply 710 may provide higher voltage levels for pulse generation. The separation of power supplies may enable stable operation and reduce noise or interference between control and high-voltage switching components.

FIG. 8A is a schematic block diagram of a voltage pulser device 802 in accordance with one or more other embodiments of the disclosure. Components in FIG. 8A having the same reference numbers may be similar to those described with respect to FIG. 7. For example, the voltage pulser device 802 of FIG. 8A may include one or more components similar to those described with respect to the voltage pulser device 112 of FIG. 7, including, for example, the digital power supply 706 (or low-voltage power supply(s)), the high-voltage power supply 710, and the pulse width generator 708. The digital power supply 706 and/or high voltage power supply 710 may be in electrical connection with the power source 718 via a power input connector 819. The voltage pulser device 802 may also include a switching stage including one or more FETs 714 (e.g., GaN FETs) configured to generate a high-voltage pulse for output to an ultrasonic transmit probe.

The voltage pulser device 802 of FIG. 8A may provide enhanced functionality relative to the embodiment of FIG. 7, including programmable control, selectable trigger modes, and configurable signal characteristics. In some embodiments, the voltage pulser device 802 may include a processing device 820 having one or more processor cores and operably coupled to memory that stores firmware 822. The processing device 820 may include, for example, a microcontroller, microprocessor, or other suitable processing circuitry. The processing device 820 may be configured to control operation of the voltage pulser device 802, including control of switching circuitry, selection of trigger sources, adjustment of pulse parameters (e.g., pulse width, pulse repetition rate, and voltage level), and coordination of signal flow through the device. For example, the processing device 820 may control operation of a trigger input selector 834, a rising/falling edge trigger selector 838, and an internal/external trigger selector 840 based on user input and/or detected signal conditions. In some embodiments, the processing device 820 may further be configured to dynamically adjust parameters of operation responsive to user inputs or stored configuration settings, and to manage timing and synchronization of generated pulses. The firmware 822 may include instructions for implementing such control logic, including signal conditioning, timing control, and user interface management.

The voltage pulser device 802 may further include a user interface to facilitate user interaction and configuration of operating parameters. For example, the user interface may include a display device such as a liquid crystal display (LCD) 824 and one or more input devices such as a membrane switch 826 or other suitable input interface (e.g., buttons, touch interface, rotary encoder, without limitation). The processing device 820 may be configured to receive one or more user inputs via the membrane switch 826 and to provide corresponding output to the LCD 824, such as visually confirming user selections, indicating an operational mode (e.g., internal trigger mode or external trigger mode), displaying selected voltage levels, pulse repetition rates, pulse width values, trigger edge selections, or other system parameters. In some embodiments, the processing device 820 may store user-defined settings and apply such settings during operation of the voltage pulser device 802.

The voltage pulser device 802 may be configured to operate in either an external trigger mode or an internal trigger mode, thereby providing enhanced flexibility and control relative to the trigger-based operation described above with respect to the voltage pulser device 112 of FIG. 7. In the external trigger mode, a trigger signal may be received from an external ultrasonic testing device (e.g., UT device 108, or the user flaw detector) via one or more trigger input paths. For example, the voltage pulser device 802 may include the low-voltage (LV) trigger input 830 and the high-voltage (HV) trigger input 832, each of which may be configured to receive a corresponding trigger signal from the ultrasonic testing device. The LV trigger input 830 and the HV trigger input 832 (e.g., each of which may be or form a “trigger input line”) may be coupled to the LV/HV trigger input selector 834 (e.g., switching circuitry, such as a multiplexer or analog switch), which may be controlled by the processing device 820 (e.g., via firmware 822) based on user selection to select one of the LV or HV trigger inputs to provide at an output 835 for further processing. In some embodiments, the trigger signal received at the LV trigger input 830 or the HV trigger input 832 may include a first voltage signal, such as one or more first voltage pulse signals. In some embodiments, the HV trigger input 832 may be configured to receive higher amplitude trigger signals, while the LV trigger input 830 may be configured for lower amplitude signals, thereby enabling compatibility with a variety of ultrasonic testing devices.

The selected external trigger signal at output 835 may be further processed by the rising/falling edge trigger selector 838, which may be configured to select either a rising edge or a falling edge of the trigger signal for use in initiating pulse generation. The rising/falling edge trigger selector 838 may include logic circuitry (e.g., combinational logic and/or edge-detection circuitry) controlled by the processing device 820 to select the desired edge based on user input. Additional details of example implementations of the rising/falling edge trigger selector 838 are described below with reference to FIG. 8C. An output of the rising/falling edge trigger selector 838 may form the external trigger signal at output 839.

In the internal trigger mode, the voltage pulser device 802 may be configured to internally generate a trigger signal independent of the external ultrasonic testing device. For example, the voltage pulser device 802 may include a pulse repetition rate generator 836 configured to generate a periodic trigger signal having a selectable pulse repetition rate. The pulse repetition rate generator 836 may be controlled by the processing device 820 (e.g., via firmware 822) to adjust the pulse repetition rate based on user input received via the user interface, such as within a selectable range (e.g., from about 100 Hz to about 2 kHz, though other ranges may be used). Additional details of example implementations of the pulse repetition rate generator 836 are described below with reference to FIG. 8B. In some embodiments, the internally generated trigger signal may be provided responsive to a user selection of the internal trigger mode. In other embodiments, the internally generated trigger signal may be automatically provided in response to a lack of detection of a valid external trigger signal, thereby enabling continued operation of the voltage pulser device 802 in the absence of an external trigger source. The internally generated trigger signal may be provided at output 837.

Selection between the internally generated trigger signal and the externally received trigger signal may be performed by the internal/external trigger selector 840 (e.g., switching circuitry such as a multiplexer or analog switch), which may be controlled by the processing device 820 based on user selection and/or operating conditions. The internal trigger signal at output 837 and the external trigger signal at output 839 may be provided as inputs to the internal/external trigger selector 840, and a selected trigger signal may be output at one or more outputs 841. The selected trigger signal at output 841 may be provided to the low-voltage trigger output 842 (e.g., for monitoring, synchronization, or output to other devices) and/or to the input of the pulse width generator 708.

The pulse width generator 708 may be configured to generate a pulse waveform having a selected pulse width responsive to the selected trigger signal at output 841. The pulse width may be adjustable (e.g., via user input and control by the processing device 820) to correspond to a frequency of a connected transducer, such as within a range from about 50 ns to about 1300 ns, or from about 65 ns to about 1275 ns, though other pulse widths may be used. In some embodiments, the pulse width generator 708 may generate one or more second voltage pulse signals having a pulse width based, at least in part, on a pulse width of one or more first voltage pulse signals received from an ultrasonic testing device or internally generated within the voltage pulser device. The output of the pulse width generator 708 may be provided to a gate driver and switching stage including the FET switch 714 (e.g., including one or more GaN FETs), which may be configured to switch a selected high voltage (e.g., selected via voltage selector circuitry and provided by the high-voltage power supply 710) to generate a high-voltage pulse at a HV pulser output 844 (e.g., which may be or form a “pulse output line”). The high-voltage pulse may include one or more second voltage pulse signals generated responsive to the first voltage signal and provided at the pulse output line to drive the monolithic transducer structure. The high-voltage pulse at the HV pulser output 844 may be provided to an ultrasonic transmit probe (e.g., a monolithic transducer structure) to generate one or more acoustic waves in a medium.

In some embodiments, the voltage pulser device 802 may further include additional input/output interfaces, such as the low-voltage trigger output 842, to provide synchronization signals to external devices or to facilitate monitoring of trigger signals. The processing device 820 may coordinate operation of the trigger selection circuitry, pulse generation circuitry, and user interface to provide a configurable and adaptable voltage pulser device capable of operating with a variety of ultrasonic testing devices and transducer configurations.

In some embodiments, operation in the internal trigger mode may provide increased flexibility for remote or constrained inspection environments. For example, by internally generating the trigger signal, the voltage pulser device 802 may reduce reliance on continuous trigger signals from the UT device 108, thereby allowing the voltage pulser device 802 and associated probe to be positioned at a distance from the UT device 108 or in locations where direct control signaling is less practical. This may facilitate inspection of difficult-to-access components, reduce cabling complexity, and improve ease of deployment in field environments.

FIG. 8B is a schematic block diagram of pulse repetition rate generator 836 of the voltage pulser device 802 of FIG. 8A in accordance with one or more embodiments of the disclosure. The pulse repetition rate generator 836 may be configured to generate a periodic trigger signal for use in the internal trigger mode of the voltage pulser device 802. For example, the pulse repetition rate generator 836 may generate a trigger signal having a selectable pulse repetition rate, which may be used to initiate pulse generation by the pulse width generator 708 as described above.

In some embodiments, the pulse repetition rate generator 836 may include a timing circuit, such as a timer device 856 (e.g., a 555 timer or similar oscillator circuit), configured to generate a periodic signal. The timer device 856 may be configured in an astable mode or other suitable configuration to generate a continuous waveform having a frequency corresponding to the desired pulse repetition rate. An output of the timer device 856 may be provided to one or more logic elements, such as an inverter, to condition the signal and provide a corresponding trigger signal at output 837.

In some embodiments, the pulse repetition rate generator 836 may include one or more adjustable components to enable user control of the pulse repetition rate. For example, the pulse repetition rate generator 836 may include one or more digitally controllable resistive elements, such as digital potentiometers 850 (e.g., digital potentiometers 852 and 854), which may be operably coupled to the timer device 856 to define timing characteristics (e.g., charge and discharge rates of a timing capacitor) of the timer device 856. In some embodiments, the digital potentiometers 852 and 854 may each include a programmable resistive element and an adjustable wiper position, which may be set in discrete increments responsive to control signals from the processing device 820. In some embodiments, the digital potentiometers 852 and 854 may be controlled by the processing device 820 (e.g., via firmware 822) using a communication interface, such as an I2C interface or other suitable interface. By adjusting the resistance values of the digital potentiometers 852 and 854, the processing device 820 may control the oscillation frequency of the timer device 856, thereby adjusting the pulse repetition rate of the generated trigger signal. In some embodiments, such digital control may enable repeatable and programmable adjustment of the pulse repetition rate without requiring manual tuning of analog components.

In some embodiments, the pulse repetition rate may be selectable over a range of frequencies, such as from about 100 Hz to about 2 kHz, though other ranges may be used depending on the application and implementation. The processing device 820 may be configured to receive a user input (e.g., via membrane switch 826) indicating a desired pulse repetition rate and to adjust the digital potentiometers 852 and 854 accordingly to achieve the selected rate. In some embodiments, the selected pulse repetition rate may be displayed on the LCD 824 to provide user feedback.

In some embodiments, the pulse repetition rate generator 836 may be selectively enabled when the voltage pulser device 802 is operating in the internal trigger mode. As described above with respect to FIG. 8A, the internally generated trigger signal at output 837 may be provided to the internal/external trigger selector 840 for selection and further processing. In some embodiments, the pulse repetition rate generator 836 may also be disabled or placed in a standby mode when the voltage pulser device 802 is operating in the external trigger mode, such that the external trigger signal is used instead.

In some embodiments, the pulse repetition rate generator 836 may provide a stable and repeatable trigger signal that enables consistent timing of generated pulses, thereby facilitating reliable ultrasonic testing operations. The use of digitally controllable components and processing device control may enable precise adjustment of the pulse repetition rate and integration with other system parameters, such as pulse width and voltage selection, as described above.

FIG. 8C is a schematic block diagram of rising/falling edge trigger selector 838 of the voltage pulser device 802 of FIG. 8A in accordance with one or more embodiments of the disclosure. The rising/falling edge trigger selector 838 may be configured to receive an external trigger signal and to selectively generate a trigger output based on either a rising edge or a falling edge of the received trigger signal. This selection may enable synchronization of pulse generation with different types of external trigger signals produced by ultrasonic testing devices.

In some embodiments, the rising/falling edge trigger selector 838 may include logic circuitry 869 configured to process the external trigger signal along multiple signal paths. For example, a first signal path may include a NOR gate 864 configured to generate a signal corresponding to one transition (e.g., a falling edge) of the external trigger signal. A second signal path may include one or more inverter gates 862 (e.g., a series of inverter stages) and a NAND gate 866 configured to generate a signal corresponding to an opposite transition (e.g., a rising edge) of the external trigger signal. The use of multiple inverter stages may provide signal conditioning and timing alignment for edge detection.

In some embodiments, outputs from the respective signal paths may be provided to a multiplexer or analog switch 868 (e.g., a 2:1 multiplexer), which may be configured to select one of the processed signals corresponding to the desired edge. The multiplexer or analog switch 868 may be controlled by the processing device 820 (e.g., via firmware 822) responsive to a user selection (e.g., via membrane switch 826) indicating whether a rising edge or a falling edge of the external trigger signal is to be used. An output of the multiplexer or analog switch 868 may form the external trigger output 839.

In some embodiments, the rising/falling edge trigger selector 838 may enable compatibility with different ultrasonic testing devices that may output trigger signals having different polarity conventions or timing characteristics. For example, some ultrasonic testing devices may generate a trigger pulse on a rising edge, while others may generate a trigger pulse on a falling edge. By enabling selection of the desired edge, the rising/falling edge trigger selector 838 may allow the voltage pulser device 802 to properly synchronize pulse generation with the external trigger signal regardless of such differences.

In some embodiments, the rising/falling edge trigger selector 838 may further provide signal conditioning, such as noise filtering, pulse shaping, or logic-level conversion, to ensure that the selected trigger signal is suitable for use by downstream circuitry (e.g., the internal/external trigger selector 840 and the pulse width generator 708). The selected trigger signal at output 839 may then be provided for further processing as described above with respect to FIG. 8A.

Accordingly, in some embodiments, an apparatus of the disclosure may include a voltage pulser device (e.g., voltage pulser device 802 of FIGS. 8A, 8B, and 8C). The voltage pulser device may include at least a trigger input line and a pulse output line. The trigger input line is configured to be coupled to an ultrasonic testing device coupled to an array transducer structure. The pulse output line is configured to be coupled to a monolithic transducer structure. The voltage pulser device is configured to receive a first voltage signal at the trigger input line; generate a second voltage signal responsive to the first voltage signal, the second voltage signal having a voltage greater than a voltage of the first voltage signal; and provide the second voltage signal at the pulse output line for driving the monolithic transducer structure to generate one or more acoustic waves to a medium. In some embodiments, the array transducer structure is configured to receive one or more acoustic waves from the medium and generate electrical signals responsive to the one or more acoustic waves, where the electrical signals are provided to the ultrasonic testing device to generate one or more images based on the electrical signals.

In some embodiments, the voltage pulser device is configured to operate in an external trigger mode to generate the second voltage signal responsive to the first voltage signal received at the trigger input line. In some embodiments, the voltage pulser device is configured to operate in an internal trigger mode as an alternative to the external trigger mode, to internally generate the first voltage signal without use of the trigger input line and to generate the second voltage signal responsive to the internally generated first voltage signal. In some embodiments, the first voltage signal includes one or more first voltage pulse signals, and the second voltage signal includes one or more second voltage pulse signals. In some embodiments, the voltage pulser device is configured to selectively operate in either the external trigger mode or the internal trigger mode based on a selection input. In some embodiments, the voltage pulser device includes a processing device having a processor core configured to control one or more parameters of operation. In some embodiments, the processing device is configured to receive a selection input to set at least a pulse repetition rate of the first voltage signal during operation in the internal trigger mode.

In some embodiments, the voltage pulser device 802 described with respect to FIGS. 8A-8C may provide enhanced configurability and control over ultrasonic signal generation relative to conventional pulser devices. For example, through use of the processing device 820 and associated control circuitry, the voltage pulser device 802 may enable user-selectable operation in either an external trigger mode or an internal trigger mode, selectable trigger edge detection, and adjustable signal parameters such as pulse repetition rate and pulse width. The integration of the pulse repetition rate generator 836 and the rising/falling edge trigger selector 838 may provide flexibility in accommodating a wide variety of ultrasonic testing devices and operational conditions, while enabling precise timing control of generated pulses.

In some embodiments, the ultrasonic testing systems and devices described herein may provide improved performance and flexibility for non-destructive testing applications, particularly in attenuative or otherwise challenging materials. For example, the use of a voltage pulser device configured to generate higher voltage signals than conventional ultrasonic testing devices may enable increased penetration of acoustic waves into a medium, while the use of separate transmitting and receiving transducer structures may enable improved signal detection and image generation. Furthermore, the incorporation of configurable signal generation, including selectable trigger modes and adjustable timing parameters, may allow the system to be adapted to a wide range of inspection scenarios, materials, and deployment environments, including remote or constrained inspection locations.

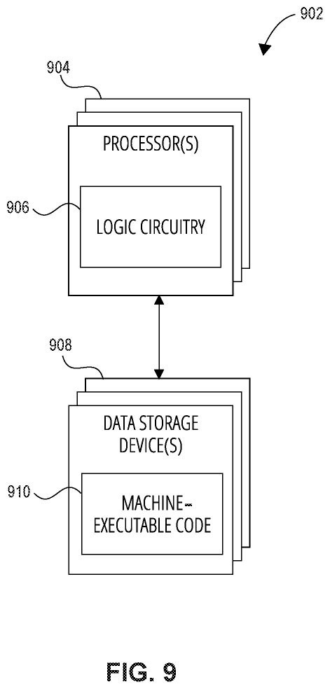

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 9 illustrates non-limiting examples of implementations of functional elements disclosed herein. In some examples, some or all portions of the functional elements disclosed herein may be performed by hardware specially configured for carrying out the functional elements.

FIG. 9 is a block diagram of circuitry 902 that, in some examples, may be used to implement various functions, operations, acts, processes, and/or methods disclosed herein. The circuitry 902 includes one or more processors 904 (sometimes referred to herein as “processors 904”) operably coupled to one or more data storage devices (sometimes referred to herein as “storage 908”). The storage 908 includes machine-executable code 910 stored thereon and the processors 904 include logic circuitry 906. The machine-executable code 910 includes information describing functional elements that may be implemented by (e.g., performed by) the logic circuitry 906. The logic circuitry 906 is adapted to implement (e.g., perform) the functional elements described by the machine-executable code 910. The circuitry 902, when executing the functional elements described by the machine-executable code 910, should be considered as special purpose hardware configured for carrying out functional elements disclosed herein. In some examples the processors 904 may perform the functional elements described by the machine-executable code 910 sequentially, concurrently (e.g., on one or more different hardware platforms), or in one or more parallel process streams.

When implemented by logic circuitry 906 of the processors 904, the machine-executable code 910 is to adapt the processors 904 to perform operations of examples disclosed herein. For example, the machine-executable code 910 may adapt the processors 904 to perform at least a portion or a totality of the method 300 of FIG. 3. As another example, the machine-executable code 910 may adapt the processors 904 to perform at least a portion or a totality of the operations discussed for the voltage pulser device 802 of FIG. 8 (e.g., where processors 904 include processing device 820 and firmware 822 of FIG. 8). As yet another example, the machine-executable code 910 may adapt the processors 904 to perform at least a portion or a totality of the operations discussed for the system of FIG. 1. As a specific, non-limiting example, the machine-executable code 910 may adapt the processors 904 to perform ultrasonic testing on a medium.

The processors 904 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 910 (e.g., software code, firmware code, hardware descriptions) related to examples of the disclosure. It is noted that a general-purpose processor (may also be referred to herein as a host processor or simply a host) may be a microprocessor, but in the alternative, the processors 904 may include any conventional processor, controller, microcontroller, or state machine. The processors 904 may also be implemented as a combination of computing devices, such as a combination of a DSP and a microprocessor, a plurality of microprocessors, one or more microprocessors in conjunction with a DSP core, or any other such configuration.

In some examples the storage 908 includes volatile data storage (e.g., random-access memory (RAM)), non-volatile data storage (e.g., Flash memory, a hard disc drive, a solid-state drive, erasable programmable read-only memory (EPROM), etc.). In some examples the processors 904 and the storage 908 may be implemented into a single device (e.g., a semiconductor device product, a system on chip (SOC), etc.). In some examples the processors 904 and the storage 908 may be implemented into separate devices.

In some examples the machine-executable code 910 may include computer-readable instructions (e.g., software code, firmware code). By way of non-limiting example, the computer-readable instructions may be stored by the storage 908, accessed directly by the processors 904, and executed by the processors 904 using at least the logic circuitry 906. Also by way of non-limiting example, the computer-readable instructions may be stored on the storage 908, transferred to a memory device (not shown) for execution, and executed by the processors 904 using at least the logic circuitry 906. Accordingly, in some examples the logic circuitry 906 includes electrically configurable logic circuitry 906.

In some examples the machine-executable code 910 may describe hardware (e.g., circuitry) to be implemented in the logic circuitry 906 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog, or very large scale integration (VLSI) hardware description language (VHDL) may be used.

HDL descriptions may be converted into descriptions at any of numerous other levels of abstraction as desired. As a non-limiting example, a high-level description may be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 906 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 910 may include an HDL, an RTL, a GL description, a mask level description, other hardware description, or any combination thereof.

In examples where the machine-executable code 910 includes a hardware description (at any level of abstraction), a system (not shown, but including the storage 908) may implement the hardware description described by the machine-executable code 910. By way of non-limiting example, the processors 904 may include a programmable logic device (e.g., an FPGA or a PLC) and the logic circuitry 906 may be electrically controlled to implement circuitry corresponding to the hardware description into the logic circuitry 906. Also by way of non-limiting example, the logic circuitry 906 may include hard-wired logic manufactured by a manufacturing system (not shown, but including the storage 908) according to the hardware description of the machine-executable code 910.

Regardless of whether the machine-executable code 910 includes computer-readable instructions or a hardware description, the logic circuitry 906 is adapted to perform the functional elements described by the machine-executable code 910 when implementing the functional elements of the machine-executable code 910. It is noted that although a hardware description may not directly describe functional elements, a hardware description indirectly describes functional elements that the hardware elements described by the hardware description are capable of performing.

As used in the disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the disclosure may be implemented as objects or processes that execute on the computing system (e.g., as separate threads). While some of the system and methods described in the disclosure are generally described as being implemented in software (stored on and/or executed by general purpose hardware), specific hardware implementations or a combination of software and specific hardware implementations are also possible and contemplated.

The illustrations presented herein are not meant to be actual views of any particular method, system, device, or structure, but are merely idealized representations that are employed to describe the examples. In some instances, similar structures or components in the various drawings may retain the same or similar numbering for the convenience of the reader; however, the similarity in numbering does not necessarily mean that the structures or components are identical in size, composition, configuration, or any other property.

The foregoing description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the disclosure unless specified otherwise herein. Elements, circuits, and functions may be shown in block diagram form in order not to obscure the disclosure in unnecessary detail. Conversely, specific implementations shown and described are exemplary only and should not be construed as the only way to implement the disclosure unless specified otherwise herein. Additionally, block definitions and partitioning of logic between various blocks is exemplary of a specific implementation. It will be readily apparent to one of ordinary skill in the art that the disclosure may be practiced by numerous other partitioning solutions. For the most part, details concerning timing considerations and the like have been omitted where such details are not necessary to obtain a complete understanding and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths, and the disclosure may be implemented on any number of data signals including a single data signal.

The various illustrative logic, blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples.

The examples herein may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

As used in the disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.,” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

While the disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An ultrasonic transducer system, comprising:
a monolithic transducer configured to transmit one or more acoustic waves into a medium;
an array transducer configured to receive one or more acoustic waves from the medium;
an ultrasonic testing device configured to transmit one or more electrical pulses toward the monolithic transducer and to receive one or more electrical signals via the array transducer; and
a voltage pulser device disposed electrically between the ultrasonic testing device and the monolithic transducer, the voltage pulser device configured to receive the one or more electrical pulses from the ultrasonic testing device and provide one or more corresponding electrical pulses to the monolithic transducer responsive to the one or more electrical pulses.

2. The ultrasonic transducer system of claim 1, wherein:
the one or more electrical pulses comprise first voltage pulse signals;
the one or more corresponding electrical pulses comprise second voltage pulse signals; and
the second voltage pulse signals have a voltage greater than a voltage of the first voltage pulse signals.

3. The ultrasonic transducer system of claim 1, wherein:
the voltage pulser device is further configured to, in an internal trigger mode, internally generate the one or more electrical pulses and to provide the one or more corresponding pulses to the monolithic transducer responsive to the internally generated one or more electrical pulses.

4. The ultrasonic transducer system of claim 2, wherein:
the monolithic transducer is configured to transmit the one or more acoustic waves into the medium responsive to receiving the second voltage pulse signals from the voltage pulser device.

5. The ultrasonic transducer system of claim 2, wherein:
the ultrasonic testing device is configured to generate an image based, at least in part, on the one or more electrical signals received from the array transducer.

6. The ultrasonic transducer system of claim 5, wherein:
the ultrasonic testing device is further configured to generate the image responsive to performing a summation processing algorithm on the one or more electrical signals received from the array transducer.

7. The ultrasonic transducer system of claim 2, wherein:
the second voltage pulse signals are based, at least in part, on a pulse duration of the first voltage pulse signals.

8. The ultrasonic transducer system of claim 2, wherein:
the first voltage pulse signals include low-voltage trigger signals having a voltage in a range from about 5 V to about 15 V or high-voltage trigger signals having a voltage of about 50 V, and wherein the second voltage pulse signals have a voltage in a range from about 100 V to about 900 V.

9. The ultrasonic transducer system of claim 1, further comprising:
a cooling device configured to reduce an operating temperature of the monolithic transducer.

10. A method of performing non-destructive testing, the method comprising:
receiving or generating a first voltage signal at a voltage pulser device;
providing, via the voltage pulser device, a second voltage signal to a monolithic transducer structure responsive to the first voltage signal, the second voltage signal having a voltage that is greater than a voltage of the first voltage signal; and
providing one or more acoustic waves to a medium using the monolithic transducer structure, the acoustic waves based, at least in part, on the second voltage signal.

11. The method of claim 10, wherein the first voltage signal is received from an ultrasonic testing device via a trigger input line of the voltage pulser device.

12. The method of claim 10, wherein the first voltage signal is generated internally by the voltage pulser device.

13. The method of claim 11, further comprising:
receiving one or more acoustic waves from the medium using an array transducer structure; and
providing a signal to the ultrasonic testing device based, at least in part, on the one or more acoustic waves.

14. The method of claim 13, further comprising:
generating, via the ultrasonic testing device, one or more images based, at least in part, on the signal.

15. An apparatus comprising:
a voltage pulser device, the voltage pulser device including at least a trigger input line and a pulse output line, the trigger input line configured to be coupled to an ultrasonic testing device coupled to an array transducer structure, the pulse output line configured to be coupled to a monolithic transducer structure, the voltage pulser device configured to:
receive a first voltage signal at the trigger input line;
generate a second voltage signal responsive to the first voltage signal, the second voltage signal having a voltage greater than a voltage of the first voltage signal; and
provide the second voltage signal at the pulse output line for driving the monolithic transducer structure to generate one or more acoustic waves to a medium.

16. The apparatus of claim 15, wherein the array transducer structure is configured to receive one or more acoustic waves from the medium and generate electrical signals responsive to the one or more acoustic waves, the electrical signals being provided to the ultrasonic testing device to generate one or more images based on the electrical signals.

17. The apparatus of claim 15, wherein the voltage pulser device is configured to operate in an external trigger mode to generate the second voltage signal responsive to the first voltage signal received at the trigger input line.

18. The apparatus of claim 17, wherein the voltage pulser device is configured to operate in an internal trigger mode as an alternative to the external trigger mode, to internally generate the first voltage signal without use of the trigger input line and to generate the second voltage signal responsive to the internally generated first voltage signal.

19. The apparatus of claim 18, wherein the voltage pulser device is configured to selectively operate in either the external trigger mode or the internal trigger mode based on a selection input.

20. The apparatus of claim 19, wherein the voltage pulser device includes a processing device having a processor core configured to control one or more parameters of operation, the voltage pulser device further configured to receive a selection input to set at least a pulse repetition rate of the first voltage signal during operation in the internal trigger mode.
